(19) United States
(12) Patent Application Publication
(10) Pub. No.: US 2017/0219823 A1
(43) Pub. Date: Aug. 3, 2017

(54) DISPLAY WITH MULTIPLE IMAGE PLANES AND COLORS

(71) Applicant: PANASONIC AUTOMOTIC SYSTEMS COMPANY OF AMERICA, DIVISION OF PANASONIC CORPORATION, PEACHTREE CITY, GA (US)

(72) Inventor: DAVID KAY LAMBERT, STERLING HEIGHTS, MI (US)

(73) Assignee: PANASONIC AUTOMOTIC SYSTEMS COMPANY OF AMERICA, DIVISION OF PANASONIC CORPORATION

(21) Appl. No.: 15/418,223

(22) Filed: Jan. 27, 2017

Related U.S. Application Data
(60) Provisional application No. 62/288,608, filed on Jan. 29, 2016.

(51) Int. Cl. G02B 27/01; G02B 26/08; H04N 13/04

(52) U.S. Cl. CPC G02B 27/0103; H04N 13/0402; H04N 13/0422; G02B 27/0179; G02B 26/0808; G02B 2027/0145; G02B 2027/0185; G02B 2027/0118

(57) ABSTRACT

A head up display arrangement for a motor vehicle includes a disc having a plurality of holographic optical elements. A motor rotates the disc. An image source produces an image. A transmissive display receives the image and collimated coherent light and projects an illuminated version of the image onto the disc. An optical element receives a reflection of the illuminated version of the image off of the disc and projects the reflection onto a windshield of the motor vehicle.

### CROSS-REFERENCED TO RELATED APPLICATIONS

This application claims benefit of U.S. Provisional Application No. 62/288,608 filed on Jan. 29, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

Although use of head up displays in motor vehicles are well known, such head up displays present images such that all the images appear to be a same distance from the human driver. That is, it is not possible for a head up display to present multiple images that appear to be different distances from the driver. Although it is currently possible to implement augmented reality displays for automotive applications, such displays occupy too much space to be practical in an automobile.

### SUMMARY

The present invention may provide a novel autostereoscopic 3D display for use by a consumer. The invention may provide a head up display that is capable of presenting to the driver virtual images that are reflected from the windshield and that appear to be localized at multiple distances in front of the driver. The virtual images may be in full color, but not necessarily. If this was attempted to be implemented in a standard automotive head up display, with enough brightness for the image to be seen in bright sunlight, the lasers would violate laser safety standards. However, the same concept may be implemented via an autostereoscopic full color display (with less brightness), which may have other applications of interest.

In one embodiment, the invention comprises a head up display arrangement for a motor vehicle, including a disc having a plurality of holographic optical elements. A motor rotates the disc. An image source produces an image. A transmissive display receives the image and collimated coherent light and projects an illuminated version of the image onto the disc. An optical element receives a reflection of the illuminated version of the image off of the disc and projects the reflection onto a windshield of the motor vehicle.

In another embodiment, the invention comprises a head up display method for a motor vehicle, including rotating a disc having a plurality of holographic optical elements. An image and collimated coherent light are received. An illuminated version of the image is projected onto the disc. An optical element receives a reflection of the illuminated version of the image off of the disc and projects the reflection onto a windshield of the motor vehicle.

In yet another embodiment, the invention comprises a head up display arrangement for a motor vehicle. The arrangement includes a rotatable disc having a plurality of holographic optical elements. An image source produces an image. A transmissive display receives the image and collimated coherent light and projects an illuminated version of the image onto the disc. An optical element receives a reflection of the illuminated version of the image off of the disc and projects the reflection onto a windshield of the motor vehicle such that a driver of the motor vehicle perceives the reflection on the windshield as having a plurality of portions each disposed within a different one of a plurality of substantially vertical viewing planes that are located at different distances from the driver.

An advantage of the present invention is that it may enable a head up display to present full-color virtual images at multiple distances to an automobile driver.

Another advantage is that, by using a sequence of holographic optical elements to create the images, the optical system can be packaged into a smaller volume than the current state of the art.

Yet another advantage is the low cost. A plastic disk containing the holographic optical elements used in the invention can be manufactured using an inexpensive process similar to that of the replication of compact discs or DVDs.

An advantage of the invention over holographic combiners used in aircraft head up displays is that, instead of putting the holographic element on the windshield, or in the direct line-of-sight of the driver, it is hidden from the driver's view.

### BRIEF DESCRIPTION OF THE DRAWINGS

A better understanding of the present invention will be had upon reference to the following description in conjunction with the accompanying drawings.

FIG. 1 is a block diagram of one example embodiment of an automotive head up display arrangement of the present invention.

FIG. 2 is a flow chart of one example embodiment of head up display method of the present invention for a motor vehicle.

### DETAILED DESCRIPTION OF THE PREFERRED EMBODIMENTS

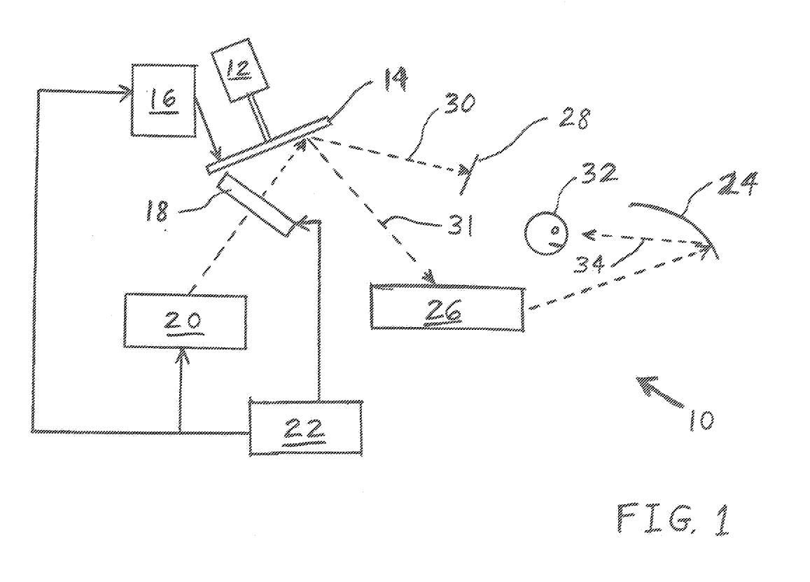

FIG. 1 illustrates one embodiment of an automotive head up display arrangement 10 of the present invention. Arrangement 10 includes a motor 12, a disk 14 with a sequence of holographic optical elements, disc indexing means 16, a transmissive display 18 (e.g., a liquid crystal display), a source 20 of collimated coherent light, possibly with selectable color, a controller and image source 22, a windshield 24, optics 26 to project light onto windshield 24, and a beam stop 28 for specularly reflected light 30. A portion of the light diffracted from disc 14 passes to optics 26, as beam labeled 31. A human driver 32 sees the light 34 reflected off of windshield 24.

Multiple holograms may be encoded on rotating disk 14, rotatingly driven by motor 12. Each hologram (holographic optical element) provides the optical mapping necessary to map an image of a particular color from a display, so the driver sees a virtual image at a given distance in front of the driver.

A sequence of holographic optical elements is encoded on disk 14. Driver 32 sees a sequence of virtual images, possibly at multiple distances and multiple colors (each as a virtual image reflected from windshield 24). Arrangement 10 may cause appropriate color coherent light to illuminate each holographic optical element of the sequence. The persistence of vision of viewer 32 causes all of the multiple images to appear to be fused together. Thus, driver 32 can see multiple full-color images at multiple distances.

Disk 14 may be rotated fast enough so the driver's persistence of vision causes the images appear to be fused together. Thus, by using holograms for three colors, and illuminating each hologram with coherent light of the appropriate color, the driver sees a full color image. Similarly, by using holograms for multiple image planes, the driver sees images that appear to be localized at multiple image planes (e.g., distances from the driver).

In one embodiment, coherent light from a laser is used as light source 20. Diode lasers are available that emit red, blue, or green light. Three diode lasers, emitting respectively red, blue, and green light, may be used for a full-color display. While lasers that emit red or blue light are well known in the art, lasers that emit green light are a recent development.

As an estimate or model of the laser characteristics needed for an automotive HUD application, consider the HUD image with a white snowbank as the background in full sunlight. In order to see a pleasing HUD image, the outside of the image may rotate by no more than one pixel while the laser is illuminating a particular holographic optical element. In one embodiment, a HUD projects a 470×136 pixel image onto a virtual image of dimensions 240×70 mm. Thus, while illuminated for a single image, the disk may rotate through an angle of no more than:

2π(70 mm/136) rad./120 mm=2.7 E-2 rad.=1.5 degrees

To fully fuse the images to create a pleasing image as perceived by almost all people, the disk may rotate at least 60 times per second. Thus, the laser pulse length may be less than:

2.7E-2 rad./[60 s⁻¹ 2π rad.]=7.1E-5 second

For a white snowbank in full sunlight, luminance is about 1E4 candela/m². At the peak of the eye visibility curve (0.55 um green light), 1 cd=1.46E-3 W/steradian. A steradian is a square radian (sr).

In one embodiment of a HUD, the eye box measures 0.13 m×0.048 m, yielding an area of 6.2E-3 m². The solid angle subtended by the virtual image as seen by the driver is:

2π(6.9°/180°) (2°/180°)=2.7E-3 sr

Consequently, for the image to be visible with a white snowbank in full sunlight as the background, the time averaged power in the image may be:

1E4 candela/m²1.46E-3 Watt/(cd sr)×6.2E-3 m²×2.7E-3 sr=2.4E-4 W.

The number of holographic optical elements on the disk may be on the order of ten. For example, with nine holographic optical elements on the disk, there could be three different distances each having three colors. Thus, the fraction of time the laser is ON may be about:

10×(2.7 E-2 rad)/(2π rad)=4.3E-3.

For a single color (e.g., green) laser, the HUD output (after reflection from the windshield) may be pulses with time length 71 μsec and maximum power of 2.4E-4 W/4.3E-3=56 mW.

Losses in the system may be taken into account. A glass windshield without coatings reflects about 39% of the s-polarized light from the HUD to be seen by the driver. Also, the fraction of incident power in the desired diffraction order reflected from the disk is estimated to be ⅓. To overcome these losses, the required maximum power is increased by a factor of 3/0.39=7.7, so the (green) laser power may be 0.43 W.

If a red, green, and blue laser are used, the power required for each laser is reduced. The estimate above is for the total power. However, the response of the eye is lower at red and blue than it is at green. Relative to a normalized or unitary response of one at the peak (green), the response at 450 nm is 0.038, and the response at 650 nm is 0.107. If lasers at these three wavelengths are used, laser powers may be 3.7 W, 0.14 W, 1.3 W, respectively, at 450 nm, 555 nm, and 650 nm, respectively.

With the system as described above, about ⅓ of the laser power may be emitted up through the windshield, which could violate laser safety guidelines. One approach to reduce the laser power is to increase the number of holographic optical elements N on the disk. The required laser power may be proportional to 1/N. Another approach is to coat the windshield with a narrow-band reflective coating that reflects at the laser wavelengths, but not at wavelengths between. This type of coating is used for military head up displays on aircraft. This would reduce the required laser power by a factor of:

1/(8E-2)=12.5.

In one embodiment, the plastic disc containing the holographic optical elements could include another “track” around the inside or outside of the disc to indicate the color of light that should be used, and the viewing plane that information is to be displayed on. The extra track could also be used to implement the system synchronizing the timing of the laser pulses with the rotation of the disc.

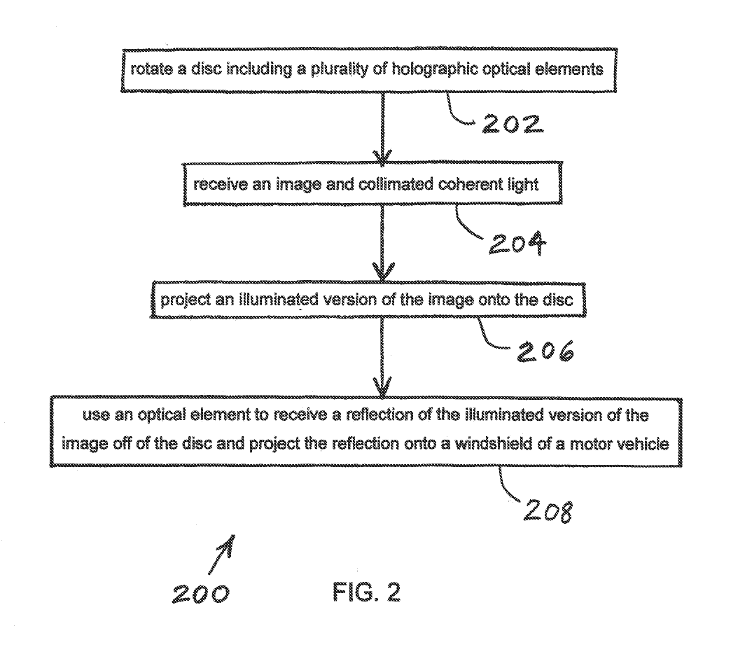

FIG. 2 illustrates one example embodiment of head up display method 200 of the present invention for a motor vehicle. In a first step 202, a disc including a plurality of holographic optical elements is rotated. For example, disk 14 may include a sequence of holographic optical elements, and may be rotatingly driven by motor 12.

In a next step 204, an image and collimated coherent light are received. For example, a transmissive display 18 may receive an image from controller and image source 22, and may receive collimated coherent light from a source 20 of collimated coherent light.

In step 206, an illuminated version of the image is projected onto the disc. That is, transmissive display 18 may project an illuminated version of the image onto disc 14. The illuminated version of the image may be based upon both the image from controller and image source 22, and the collimated coherent light from source 20 of collimated coherent light.

In a final step 208, an optical element is used to receive a reflection of the illuminated version of the image off of the disc and project the reflection onto a windshield of the motor vehicle. For example, optics 26 receives a portion of the light diffracted from disc 14 as beam 31, and projects the light onto windshield 24.

While this invention may provide a means to implement a head up display, there are other potential applications. For example, it could be used to implement a 3D display that does not require special glasses (autostereoscopic) for any consumer electronics use such as television viewing or computer gaming.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
a disc including a plurality of holographic optical elements;
a motor configured to rotate the disc;
an image source configured to produce an image;
a source of collimated coherent light;
a transmissive display configured to receive the image and the collimated coherent light and project an illuminated version of the image onto the disc; and
an optical element configured to receive a reflection of the illuminated version of the image off of the disc and project the reflection onto a windshield of the motor vehicle.

2. The head up display arrangement of claim 1 wherein the transmissive display comprises a liquid crystal display.

3. The head up display arrangement of claim 1 wherein the holographic optical elements cause a driver of the motor vehicle to perceive the reflection projected onto the windshield as including a plurality of portions each being disposed at a different respective distance from the driver.

4. The head up display arrangement of claim 1 wherein the illuminated version of the image includes a plurality of colors such that the holographic optical elements cause a driver of the motor vehicle to perceive the reflection projected onto the windshield as including a plurality of portions each being of a different respective one of the colors.

5. The head up display arrangement of claim 1 further comprising:
a disc indexing device coupled to the disc; and
an electronic controller communicatively coupled to:
the disc indexing device;
the source of collimated coherent light; and
the transmissive display.

6. The head up display arrangement of claim 1 further comprising a beam stop configured to block specularly reflected light from the disc or diffracted light from the disc.

7. The head up display arrangement of claim 1 wherein the disc includes a track indicating a color of light and a viewing plane corresponding to each said holographic optical element.

8. A head up display method for a motor vehicle, the method comprising:
rotating a disc including a plurality of holographic optical elements;
receiving an image and collimated coherent light;
projecting an illuminated version of the image onto the disc; and
using an optical element to receive a reflection of the illuminated version of the image off of the disc and project the reflection onto a windshield of the motor vehicle.

9. The head up display method of claim 8 wherein the receiving and projecting steps and performed by a transmissive display.

10. The head up display method of claim 9 wherein the transmissive display comprises a liquid crystal display.

11. The head up display method of claim 8 wherein the holographic optical elements cause a driver of the motor vehicle to perceive the reflection projected onto the windshield as including a plurality of portions each being disposed at a different respective distance from the driver.

12. The head up display method of claim 8 wherein the illuminated version of the image includes a plurality of colors such that the holographic optical elements cause a driver of the motor vehicle to perceive the reflection projected onto the windshield as including a plurality of portions each being of a different respective one of the colors.

13. The head up display method of claim 8 further comprising:
coupling a disc indexing device to the disc; and
coupling an electronic controller to:
the disc indexing device;
a source of the collimated coherent light; and
a transmissive display that performs the receiving and projecting steps.

14. The head up display method of claim 8 further comprising using a beam stop to block specularly reflected light from the disc or diffracted light from the disc.

15. The head up display method of claim 8 wherein the disc includes a track indicating a color of light and a viewing plane corresponding to each said holographic optical element.

16. A head up display arrangement for a motor vehicle, the arrangement comprising:
a rotatable disc including a plurality of holographic optical elements;
an image source configured to produce an image;
a source of collimated coherent light;
a transmissive display configured to receive the image and the collimated coherent light and project an illuminated version of the image onto the disc; and
an optical element configured to receive a reflection of the illuminated version of the image off of the disc and project the reflection onto a windshield of the motor vehicle such that a driver of the motor vehicle perceives the reflection on the windshield as having a plurality of portions each disposed within a different one of a plurality of substantially vertical viewing planes that are located at different distances from the driver.

17. The head up display arrangement of claim 16 wherein the illuminated version of the image includes a plurality of colors such that the holographic optical elements cause a driver of the motor vehicle to perceive the portions of the reflection projected onto the windshield as each being of a different respective one of the colors.

18. The head up display arrangement of claim 16 further comprising:
a disc indexing device coupled to the disc; and
an electronic controller communicatively coupled to:
the disc indexing device;
the source of collimated coherent light; and
the transmissive display.

19. The head up display arrangement of claim 16 further comprising a beam stop configured to block specularly reflected light from the disc or diffracted light from the disc.

20. The head up display arrangement of claim 16 wherein the disc includes a track indicating a color of light and a said viewing plane corresponding to each said holographic optical element.
